(19) United States
(12) Patent Application Publication
(10) Pub. No.: US 2015/0285725 A1
(43) Pub. Date: Oct. 8, 2015

(54) Method and Apparatus for Determining Wettability of Materials

(71) Applicant: SCHLUMBERGER TECHNOLOGY CORPORATION, Sugar Land, TX (US)

(72) Inventors: Mikhail Stukan, Al-Khobar (SA); Patrice Ligneul, Chaville (FR)

(21) Appl. No.: 14/646,017

(22) PCT Filed: Nov. 21, 2013
(86) PCT No.: PCT/EP2013/074395

§ 371 Date: May 19, 2015

Related U.S. Application Data
(60) Provisional application No. 61/729,314, filed on Nov. 21, 2012.

(30) Foreign Application Priority Data
Nov. 22, 2012 (EP) 12306451.1

(51) Int. Cl. G01N 13/00; G01N 25/00

(52) U.S. Cl. CPC G01N 13/00; G01N 25/00

(57) ABSTRACT

An apparatus to measure temperature difference between a first side of a wall of at least one known material and a fluid contacting said first side. A method to determine wettability of at least one known material for a given fluid comprising measuring the thermal difference between a first side of a wall of the at least one known material and the given fluid contacting said first side.

### FIELD OF THE DISCLOSURE

The disclosure is related to investigation of surface properties, particularly, to determination of wettability of materials. This disclosure may be used in different areas of industry, particularly, in the oil and gas industry, the chemical industry, the paint-and-coating industry, and the food industry.

### BACKGROUND OF THE DISCLOSURE

Wettability is an important phenomenon greatly impacting specifics of fluid distribution and propagation in a media. Thus, being a key parameter for characterizing oil formation and simulation, wettability greatly affects rock filtration properties, like relative permeability and displacement coefficient.

Wettability can be derived from the evaluation of affinity of fluids with an adjacent solid surface by analysis of the temperature distribution in the vicinity of the wall in the fluid when heated by a thermal gradient at the wall. The so-called Kapitza jump (difference between the wall temperature and the fluid temperature close to the wall) is a function of the affinity of the fluid with the wall, and then of wettability of the fluid on the wall.

The subject of thermal conductivity through the interfaces has already been raised in the literature. Experimental articles consider specific set ups, e.g. water-gold [See at H. Ghasemi and C. A. Ward, Mechanism of Sessile Water Droplet Evaporation: Kapitza Resistance at the Solid-Liquid Interface, J. Phys. Chem. C, 115, 21311-21319, 2011] or in liquid helium environment [See at Amrit, J. P. Thermeau, Measurements of the Kapitza resistance between Silicon and helium from 0.4 K to 2.1 K, J. Phys.: Conf Series, 150, 032002, 2009]. Also, the subject was performed using molecular dynamics simulation [See J.-L. Barrat and F. Chiaruttini, Kapitza resistance at the liquid-solid interface, Mol. Phys. 101, 1605-1610, 2003 or B. H. Kim, A. Beskok, T. Cagin, Thermal interactions in nanoscale fluid flow: molecular dynamics simulations with solid-liquid interfaces. Microfluid Nanofluid, 5, 551-559, 2008 or B. H. Kim, A. Beskok, T. Cagin, Molecular dynamics simulations of thermal resistance at the liquid-solid interface. J. Chem. Phys. 129, 174701, 2008 or S. Murad, I. K. Puri, Thermal transport across nanoscale solid-fluid interfaces. Appl. Phys. Lett. 92, 133105, 2008 or L. Xie, P. Keblinski, S. R. Phillpot, S. U.-S. Choi, J. A. Eastman, Two regimes of thermal resistance at a liquid-solid interface. J. Chem. Phys. 118, 337-339, 2003], which has demonstrated the dependence of the temperature jump on the fluid-solid affinity (wettability).

However, no use has been made of thermal resistance as a measure of surface-liquid affinity (wettability) and no such apparatus has ever been disclosed.

### SUMMARY OF THE DISCLOSURE

It is proposed an apparatus and method to determine wettability of at least one known material with a fluid by measuring temperature difference between a first side of a wall of the at least one known material and the fluid contacting said first side.

### BRIEF DESCRIPTION OF THE DRAWINGS

To assist those of ordinary skill in the relevant art in making and using the subject matter hereof, reference is made to the appended drawings, in which like reference numerals refer to similar elements:

FIG. 1 shows an example of geometry for establishing the basic theory of temperature distribution in a 2D channel.

FIG. 2 shows one example of the proposed apparatus;

FIG. 3 represents another example of the proposed apparatus;

FIG. 4 shows an example with a Peltier cell;

FIG. 5 shows detail of an alternative design of the proposed apparatus.

These together with other aspects, features, and advantages of the present disclosure, along with the various features of novelty, are pointed out with particularity in the claims annexed to and forming a part of this disclosure. The above aspects and advantages are neither exhaustive nor individually or jointly critical to the spirit or practice of the disclosure. Other aspects, features, and advantages of the present disclosure will become readily apparent to those skilled in the art from the following description of exemplary embodiments in combination with the accompanying drawings. Accordingly, the drawings and description are to be regarded as illustrative in nature, and not restrictive. This summary is not intended to identify key or essential features of the claimed subject matter, nor is it intended to be used as an aid in limiting the scope of the claimed subject matter.

It should be understood that the drawings are not to scale and that the disclosed embodiments are sometimes illustrated diagrammatically and in partial views. In certain instances, details that are not necessary for an understanding of the disclosed method and apparatus or that would render other details difficult to perceive may have been omitted.

### DETAILED DESCRIPTION

Some embodiments will now be described with reference to the figures. Like elements in the various figures may be referenced with like numbers for consistency. In the following description, numerous details are set forth to provide an understanding of various embodiments and/or features. However, it will be understood by those skilled in the art that some embodiments may be practiced without many of these details and that numerous variations or modifications from the described embodiments are possible. As used here, the terms “above” and “below”, “up” and “down”, “upper” and “lower”, “upwardly” and “downwardly”, “upstream” and “downstream”, and other like terms indicating relative positions above or below a given point or element are used in this description to more clearly describe certain embodiments. However, when applied to equipment and methods for use in wells that are deviated or horizontal, such terms may refer to a left to right, right to left, or diagonal relationship, as appropriate.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both objects or steps, respectively, but they are not to be considered the same object or step.

The terminology used in the description herein is for the purpose of describing particular embodiments only and is not intended to be limiting of the disclosure and embodiments presented herewith. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

In the specification and appended claims, the terms/phrases “connect”, “connection”, “connected”, “in connection with”, and “connecting” are used to mean “in direct connection with” or “in connection with via one or more elements”, and the term “set” may mean “one element” or “more than one element”. Further, the terms “couple”, “coupling”, “coupled”, “coupled together”, and “coupled with” are used to mean “directly coupled together” or “coupled together via one or more elements”.

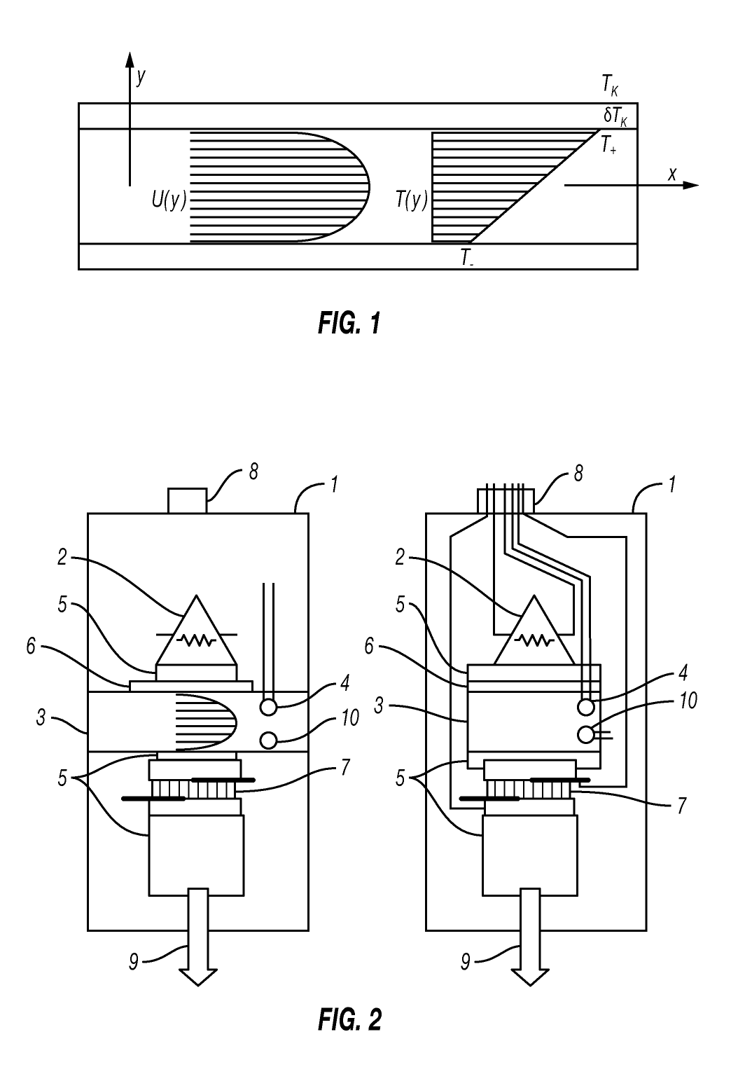

For establishing basic reference it is described an example of the flow and temperature profiles of a fluid embedded in a quasi 2D channel of walls of temperatures T₊=T(h) at y=h and T₋=T(−h) at y=−h . The fluid entering the channel is supposed to be at the temperature T₀, but the equilibrium temperature distribution is supposed to be dependent on the temperature of the upper and lower surfaces (in FIG. 1) and independent on T₀.

In terms of condensed matter approach, this is a solution of the Navier Stokes equation (as seen in Schlichting, Boundary layer Theory, McGraw Hill 7^{th} edition). When the system is in balance (no more longitudinal gradients), the energy equation results in:

$$k \frac{{d}^{2} T}{d {y}^{2}} = - μ {( \frac{d u}{d y} )}^{2} \qquad 1$$

For a Couette flow (parallel between to plates):

$$\begin{matrix}u ( y ) = {U}_{m} ( 1 - \frac{{y}^{2}}{{h}^{2}} ) \\ Thus & 2 \\ \frac{{d}^{2} T}{d {y}^{2 }} = - \frac{4 μ {U}_{m}}{{kh}^{4}} {y}^{2} & 4\end{matrix}$$

The gradient is:

$$\frac{d T}{d y} = - \frac{4 μ {U}_{m}}{3 {kh}^{4}} {y}^{3} + F \qquad 5$$

And the temperature distribution:

$$T ( y ) = - \frac{μ {U}_{m}}{3 {kh}^{4}} {y}^{4} + Fy + G \qquad 6$$

At the upper wall T₊=T(h) and the lower wall T₋=T(−h) the wall temperatures:

$$\frac{{T}_{+} - {T}_{-}}{2 h} = F and \frac{{T}_{+} + {T}_{-}}{2} + \frac{μ {U}_{m}}{3 k} = G \\ T ( y ) = \frac{μ {U}_{m}}{3 k} ( 1 - \frac{{y}^{4}}{{h}^{4}} ) + \frac{( {T}_{+} - {T}_{-} )}{2} \frac{y}{h} + \frac{( {T}_{+} + {T}_{-} )}{2} \qquad 7$$

In a non dimensional frame:

$$\frac{2 T ( y )}{( {T}_{+} + {T}_{-} )} = \frac{μ {U}_{m}}{3 k ( {T}_{+} + {T}_{-} )} ( 1 - \frac{{y}^{4}}{{h}^{4}} ) + \frac{( {T}_{+} - {T}_{-} )}{( {T}_{+} + {T}_{-} )} \frac{y}{h} + 1 \qquad 8$$

For instance for water:

μ≅10⁻³, k=0.6. With a channel 2h≅mm a temperature difference of (T₊−T₋)=4 K, at 293K, the first term of this equation is almost neglectible as soon as the velocity is below a few meters per second, the effective condition is:

$${U}_{m} << \frac{ 3 k ( {T}_{+} - {T}_{-} )}{μ} \qquad 9$$

The flux of energy across the channel is:

Upper wall

$${Φ}_{+} = k \frac{d T}{d y} ( y = h ) = k \frac{{T}_{+} - {T}_{-}}{2 h} - \frac{4 k μ {U}_{m}}{3 h} \qquad 10$$

Lower wall

$${Φ}_{-} = k \frac{d T}{d y} ( y = - h ) = k \frac{{T}_{+} - {T}_{-}}{2 h} + \frac{4 k μ {U}_{m}}{3 h} \qquad 11$$

In case of small velocities, as according to equation 9, Φ₊=Φ₋.

Here Φ is the thermal flux in (J/m²s) that might be created for example by a thermal resistance RI²/m²s or W/m² or a Peltier cell for cooling. Creating a constant thermal flux enables to create a constant temperature gradient in the channel, which means that the evacuated flux Φ₋ might be “pumped” by a proper thermal conductor.

If we consider T₊ and T₋ being the temperatures inside the fluid, the same equations as 1 to 10 apply to the temperature distribution inside the fluid. Close to the boundary we can introduce an artificial layer through which the Kapitza jump ΔTₖ=(T_{w}−T₊) might be described over a continuous medium of thickness δ_{K} and thermal conductivity k_{K} (here close to the upper wall for instance).

In this layer using equation 7, and neglecting the velocity (we are close to the wall):

$$T ( y ) = \frac{Δ {T}_{k}}{2} \frac{y}{{δ}_{K}} + \frac{( {T}_{+} + {T}_{-} )}{2} \qquad 12$$

The flux entering in the Kapitza layer is constant inside the Kapitza layer and can be written as:

$${Φ}_{K} = {k}_{K} \frac{Δ {T}_{k}}{2 {δ}_{K}} = k \frac{{T}_{+} - {T}_{-}}{2 h} \qquad 13$$

The thermal flux shall not depend on flowrate.

The introduction of an artificial boundary layer of Kapitza length thickness allows writing continuous temperature boundary conditions at the wall/Kapitza layer, where T_{w} is the temperature measured in the solid part at the wall location and T₊ the temperature in the fluid the other side of the Kapitza layer.

$${T}_{w} - Δ {T}_{K} = {T}_{+} , {T}_{m} ≅ \frac{( {T}_{+} + {T}_{-} )}{2} \qquad 14$$

The temperature T₋ is the measurement of the temperature at the opposite wall, the temperature T₊ might not be easily measured at the wall but Tₘ might be measured for instance in the middle of the channel (y=0), thus T₊≅2Tₘ−T₋.

The power coming from the wall by, for example, a thermistance and passed to the system is:

Φ_{w}=AI²=Φ_{K} 15

A is a constant of calibration depending on the system embodiment, I is the current put in the heating device that can be adjusted for varying the conditions. To ensure a proper gradient across the channel a Peltier cell (or any heat exchanger) might be put on the other side.

If the fluid flow is moderated (satisfying equation 9), then the first term of equation 6 might be dropped and the distortion of the temperature field might be linear between the two walls. Then parallel channels might be used to estimate the affinity of the fluid with different solid materials.

A multi measurement of temperature might be made inside the fluid along a cross section of a capillary of circular or rectangular cross section. The so called KAPITZA jump, is a measurement of the affinity between surface and fluid related to wettability because the Kapitza “jump” differs from the continuous thermal dissipation in a fluid by a “standard” heating wall condition (as seen in equations 12 to 15).

In one example, the proposed method uses the evaluation of a change of the thermal profile inside the fluid perpendicular to the axis of the cylinders along the walls, and a theoretical extrapolation of this gradient up to the wall by the heat equation (continuous) and comparison to the measured temperature at the wall. The difference between actual surface temperature and the calculated one might provide Kapitza jump and thus the Kapitza length value.

The Kapitza length is of the order of some nanometers but the jump itself might be of order of several degrees K (see references). The wettability effect appears as a boundary layer effect that is not visible “afar” from the wall but the jump itself might be estimated by the control of the wall temperature. An other way to estimate the Kapitza jump might be to evaluate the difference between the fluid and wall temperature when the fluid emerges form the thermalized capillary through which it entered at a different temperature.

As showed from example of FIG. 2, a rectangular microfluidic flow line 3, (for instance about 0.5 mm thick, about 2 mm wide) is heated by a resistor 2 through a diamond layer 5 (for instance), and a material to be studied with the fluid 6.

In this example, a Peltier cell 7, cools down the channel through the diamond layer 5, and evacuate the heat by a thermal conductor (that might be diamond also) to a reservoir of heat through 9. The temperature T_{w} is obtained at 2, temperature Tₘ is obtained at 4, the temperature T₋ is obtained at 10. The system might be embedded in a thermal insulator 1 except from 5 (the cooling Peltier cell) to 9 where the heat should be evacuated out from the device. A connector 8 might be chosen to pass the wires from the device to electronics (not showed).

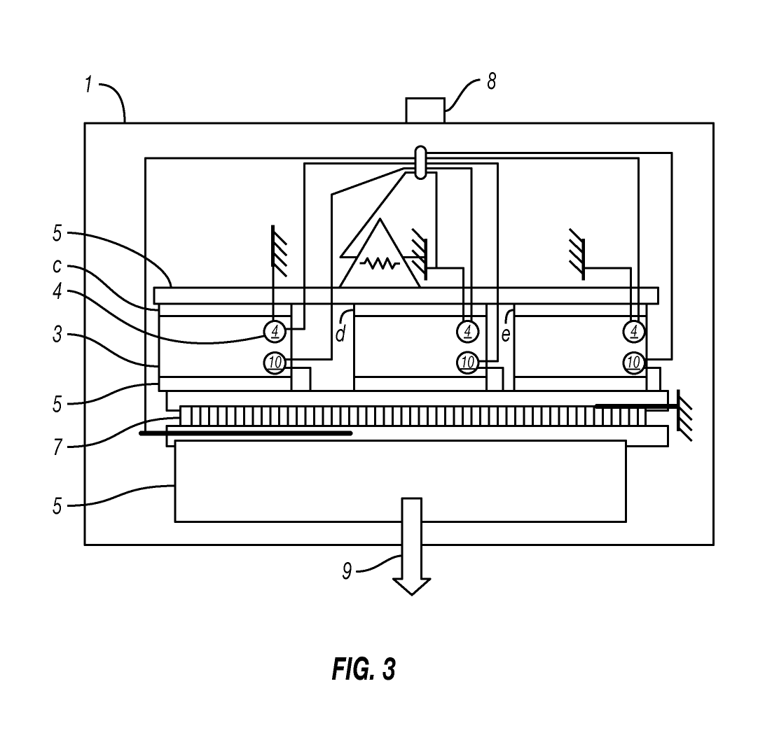

Represented on FIG. 3, a similar embodiment might be done with multichannels C₁ C₂ . . . Cᵢ. The cross section of the channels might be rectangular in the sub millimeter range. They can arranged, for example, in parallel where a single heat source 2, might be in contact with the parallel channels covered with various material layers (as showed by references c, d, e, . . . ). Each channel might be cut in an insulating material 1, with a thermal conductor as a diamond layer (5) placed above heat exchanger like a Peltier cell that pumps energy and cools down the fluid. The temperature T₋ is measured at 10 close to bottom 5, the diamond layer in each channel.

The measurements of temperature might be done in 2 (that might be thermalized by a calorific carrier 5), and, for example, at two locations in each channel according to model 14, reused for each channel. Heat might be pumped and evacuated by a Peltier cell in a thermalized piece of high thermal conductivity.

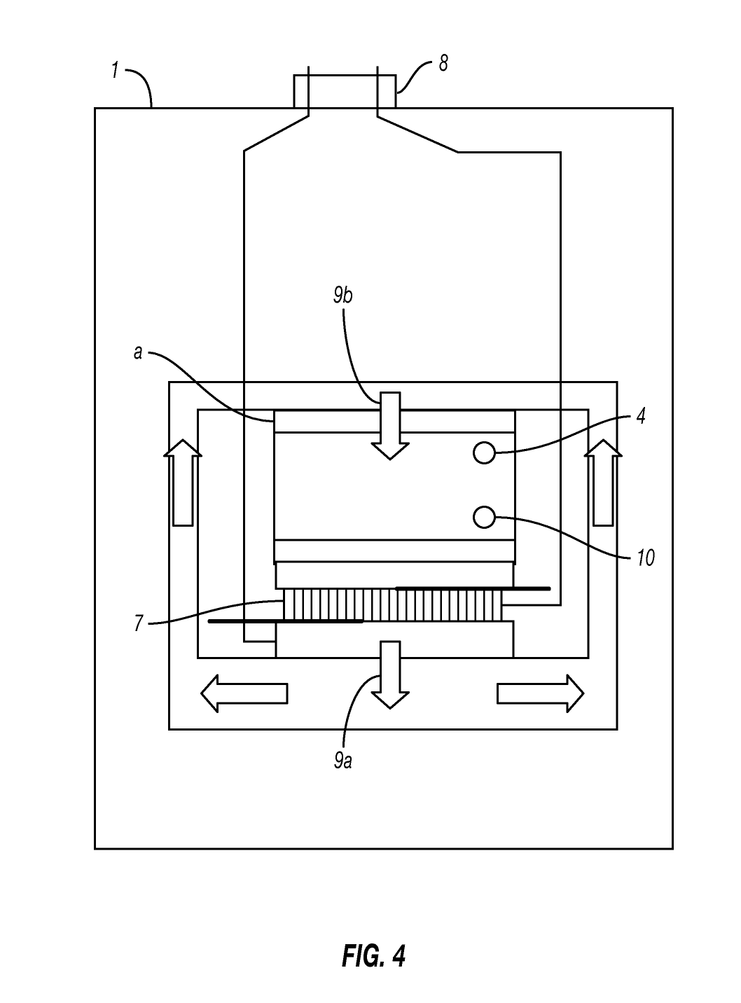

An alternative in the sketch of FIGS. 2 and 3 is to use the Peltier cell as a generator of heat where the cold source is at the same place but the heated energy is transmitted as a loop of thermal flux on the top of the material to be tested (principle in FIG. 4).

The medium 5 might be a thermally conductive material (for instance Carbon nanotubes (thermal coefficient can be greater than 4000 W/m·K. Diamond can reach the value of 3300 W/m·K graphene can reach almost 5000 W/m·K, while for instance the bulk of the system is in Peek (its conductivity is as low as 0.25 W/m·K). Artificial diamond, graphene layers, carbo-nano-tubes, might be used for this purpose.

In FIG. 4, the Peltier cell might be used as energy provider to create a constant thermal gradient in the system. The electric energy entering in 7 might be adjusted such as the evacuated heat (9a) is conducted to the upper surface to heat the tested plate with a flux 9b (which is the same as 9a minus the lost flux in the bulk insulator 1). The temperatures of the system might be measured in a, 4, 10 locations to estimate the Kapitza jump as described in equations 1 to 15.

In one example, the system comprises heating elements (for example diamond for it excellent thermal conductivity) on which deposition of pure rock material might be achieved (calcite, dolomite, SiO2, quartz etc.). Since it would might be difficult to measure the real temperature of this multilayer systems one example of the method is to use “reference” material to which the wettability of fluids can be estimated in a relative mode, creating a hierarchy of wettability for the fluid with the reference materials.

It then might be helpful to make a series of experiments with the same fluids and the reservoir rocks to be studied (as a calibration methodology). For instance pure calcite or calcite aged in a given crude oil containing wettability agents (like resins, aromatics, asphaltenes or carboxylic acids).

Then the combination of reference materials and reservoir materials might be made to create a homeomorphic mapping between the measurement made by the device and the actual coupling between reservoir fluids and rock.

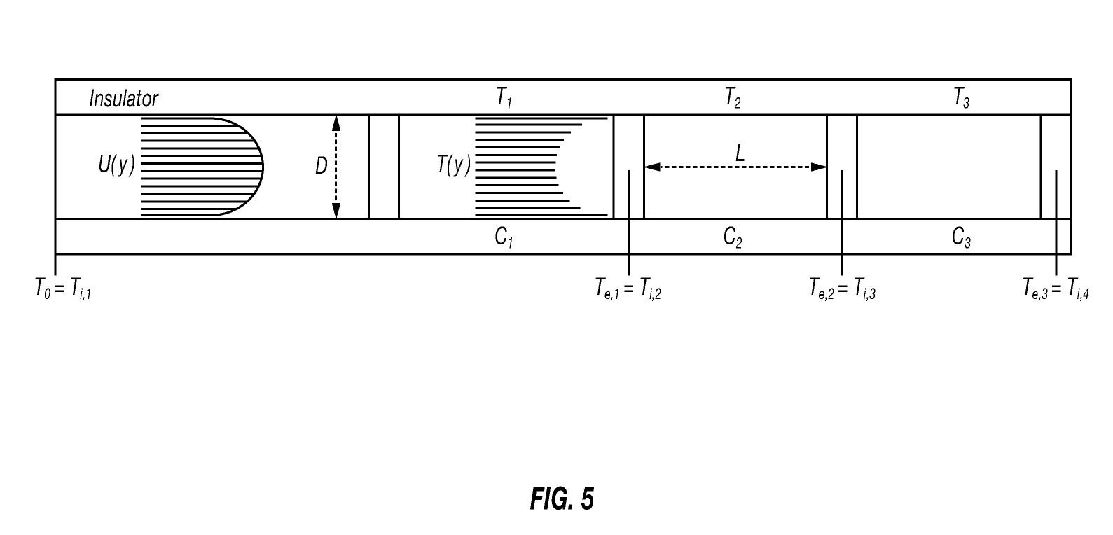

In alternative examples, shown in FIG. 5, the apparatus might be made of several cylindrical capillaries C₁ C₂ . . . Cᵢ of circular cross section. The capillaries might arranged sequentially in series. The capillary walls might be set at temperatures T₁ T_{2 . . . T}ᵢ.

Also, the capillaries might be of same diameter D and length L but should be independent in terms of thermal propagation.

The initial (upstream) temperature of the fluid is T₀ and is pumped through the sequence of cylinders. Fluid flow might be laminar (Reynolds number VD/v<<1000).

Also, the temperature might be measured at each entrance T_{i,i} and outlet T_{e,i} of the capillaries Cᵢ.

In one aspect, the measurement of the influence of so called KAPITZA length, which is a measurement of the affinity between surface and fluid, on the fluid heating might be provided. This is related to wettability by a Kapitza “jump” that differs from the continuous thermal dissipation in a fluid by a “standard” heating wall condition.

Examples of the proposed method therefore might also include the evaluation of a change of the thermal profile inside the fluid perpendicular to the axis of the cylinders between the walls, make a theoretical extrapolation of this gradient up to the wall by the heat equation (continuous) and compared to the measured temperature at the wall.

The difference between actual temperature of the fluid at the exit of the capillary and the calculated one might also provide Kapitza length value. The Kapitza length may be of order or some nanometers but the jump itself might be of order of several degrees K (see references).

The wettability effect appears as a boundary layer effect that is not visible “afar” from the wall but the jump itself might be estimated by the control of the wall temperature.

The system might comprise heating elements on which deposition of pure rock material might be achieved (calcite, dolomite, SiO2, quartz etc.). Since it might be very difficult to measure the real temperature of this multilayer systems, in one embodiment we may use “reference” material to which the wettability of fluids might be estimated in a relative mode, creating a hierarchy of wettability for the fluid with the reference materials.

It might be necessary to make a series of experiments with the sample fluids and the reservoir rocks to be studied (as a calibration methodology): for instance pure calcite or calcite aged in a given crude oil containing wettability agents (like resins, aromatics, asphaltenes or carboxylic acids). Then, the combination of reference materials and reservoir materials might be made to create a homeomorphic mapping between the measurement made by the device and the actual coupling between reservoir fluids and rock.

In FIG. 5, the fluid enters a series of capillaries. Its initial temperature T₀ might be measured in the middle of the channel by a Temperature Control Device (a resistor, or a junction) and passed through the first channel at T₁. At the outlet section of the temperature, T_{e,1} is different that the wall temperature T₁. This difference might be linked to the Kapitza jump which occurs close to the wall. This fluid temperature becomes temperature T_{i,2}the inlet temperature for the second capillary C₂. The process might be repeated as many times as needed.

In the nonwetting cases, the coupling between the solid and the liquid might be significantly reduced and 1_{K} might reach 50 molecular diameters [See J.-L. Barrat and F. Chiaruttini, Kapitza resistance at the liquid-solid interface, Mol. Phys. 101, 1605-1610, 2003] (10-20 nm). However, according to the recent data by H. Ghasemi and C. A. Ward, Mechanism of Sessile Water Droplet Evaporation: Kapitza Resistance at the Solid-Liquid Interface, J. Phys. Chem. C, 115, 21311-21319, 2011, the temperature jump at the interface at room temperature can be as large as 2° C. for the case of a water drop on gold surface. Therefore, although the Kapitza length itself is not an easy measurable parameter, it might be possible to measure the temperature jump at the solid-liquid border interface. This should result in the temperature difference between the surface and the bulk fluid.

Kapitza length can be considered in analogy to the slip length. Both are related to the ability of the solid to transfer momentum to the liquid. This ability is weaker when the liquid does not wet the solid (has small affinity to the surface), since in this case the liquid density is depleted in the vicinity of the solid wall. When the solid/liquid interactions shall be strong (high affinity) there shall be no momentum deficit at the wall/liquid and there is no temperature jump and the Kapitza length tends to zero.

While only certain embodiments have been set forth, alternatives and modifications will be apparent from the above description to those skilled in the art. These and other alternatives are considered equivalents and within the scope of this disclosure and the appended claims. Although only a few example embodiments have been described in detail above, those skilled in the art will readily appreciate that many modifications are possible in the example embodiments without materially departing from the present disclosure. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

1. An apparatus to measure temperature difference between a first side of a wall of at least one known material and a fluid contacting said first side.

2. The apparatus according to claim 1, comprising at least one channel of the at least one known material through which the fluid is flowing.

3. The apparatus according to claim 2, wherein the at least one channel is a micro-channel having a diameter of about hundredths of micro-meters.

4. The apparatus according to claim 2, wherein the at least one channel comprises diamond layers over which the at least one known wall material is deposited.

5. The apparatus according to claim 4, wherein the at least one known material is deposited by microdeposition.

6. The apparatus of claim 1, wherein the at least one known material comprises calcite crystals, carbonate rocks or sandstones.

7. The apparatus of claim 1, wherein the fluid comprises brine and/or oil of various composition.

8. (canceled)

9. The apparatus of claim 1, further comprising thermally insulating material surrounding the at least one known material.

10. (canceled)

11. The apparatus of claim 1, further comprising heat exchanger means connected to the second side of the wall of the at least one known material.

12. (canceled)

13. The apparatus according to claim 12, wherein the Peltier cell is connected with the second side of the wall of the at least one known material and with a diamond channel used as a thermal duct.

14. The apparatus of claim 1, further comprising thermal sensors to measure said temperature difference.

15. The apparatus according to claim 14, wherein the thermal sensors comprise micro thermal sensors located along the at least one known material.

16. The apparatus according to claim 14, wherein the thermal sensors comprise RTD platinium resistance temperature sensors.

17. The apparatus of claim 2, comprising a plurality of channels.

18. The apparatus of claim 17, wherein the plurality of channels comprise series of capillaries coated with a plurality of known materials.

19. The apparatus of claim 18, wherein each capillary is thermalized at a temperature and is long enough to enable the fluid flowing at the end of the capillary to be at equilibrium with said temperature.

20. (canceled)

21. A method to determine wettability of at least one known material for a given fluid comprising measuring the thermal difference between a first side of a wall of the at least one known material and the given fluid contacting said first side.

22. The method of claim 21, wherein the thermal difference comprises the Kaptiza thermal jump between the first side of the wall of the least one known material and the given fluid.

23. The method of claim 21, wherein the wettability of the fluid with the least one known material is inversely proportional to the Kaptiza thermal jump.

24. The method of claim 21, wherein the thermal difference is measured for a plurality of fluids and the at least one known material.

25. (canceled)

26. The method of claim 21, comprising heating the second side of the wall of the least one known material.

27. A method to determine wettability of at least one known material with a given fluid by analysis of the temperature distribution in the given fluid in the vicinity of a solid surface of the at least one known material when said solid surface is heated by a thermal gradient.
